(19) United States
(12) Patent Application Publication
(10) Pub. No.: US 2016/0130418 A1
(43) Pub. Date: May 12, 2016

(54) TIRE COMPRISING A RUBBER COMPOSITION COMPRISING AN OLEFINIC EPOXIDE ELASTOMER CROSS-LINKED BY A POLYCARBOXYLIC ACID

(71) Applicants: MICHELIN RECHERCHE ET TECHNIQUE S.A., Granges-Paccot (CH); COMPAGNIE GENERALE DES ETABLISSEMENTS MICHELIN, Clermont-Ferrand (FR)

(72) Inventors: BENOIT SCHNELL, Clermont-Ferrand (FR); ETIENNE FLEURY, Clermont-Ferrand (FR)

(21) Appl. No.: 14/893,759

(22) PCT Filed: May 23, 2014
(86) PCT No.: PCT/EP2014/060686

§ 371 Date: Nov. 24, 2015

(30) Foreign Application Priority Data
May 28, 2013 (FR) 1354833

(51) Int. Cl. C08K 3/36

(52) U.S. Cl. CPC C08K 3/36

(57) ABSTRACT

A tire comprises a rubber composition based on at least one olefinic elastomer comprising epoxide functional groups as predominant elastomer, at least one reinforcing filler, and a crosslinking system comprising a polycarboxylic acid of general formula (I):

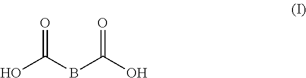

in which B represents a hydrocarbon group which comprises at least 50 carbon atoms, which is optionally substituted and which is optionally interrupted by one or more heteroatoms, and an imidazole of general formula (II):

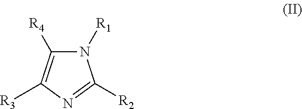

in which R₁ represents a hydrocarbon group or a hydrogen atom, R₂ represents a hydrocarbon group, R₃ and R₄ represent, independently of one another, a hydrogen atom or a hydrocarbon group, or else R₃ and R₄ form, together with the carbon atoms of the imidazole ring to which they are attached, a ring.

The present invention relates to tyres provided with rubber compositions, in particular with rubber compositions based on olefinic elastomers comprising epoxide functional groups.

It is an ongoing objective for tyre manufacturers to find solutions in order to improve the endurance of tyres; specifically, it is desirable to produce rubber mixtures having stable properties over time, this being the case despite the repetition of mechanical and thermal stresses during the life of the tyre. In particular, it is important for the compositions of the various semi-finished products participating in the composition of tyres, such as, for example, treads, to exhibit good resistance to thermal oxidation which, with use of the tyre, can modify its performance.

Ideally, for example, a tyre tread must fulfil a great many technical requirements, which are often contradictory in nature, including a high wear resistance while affording the tyre a low rolling resistance and high grip, both on dry ground and on wet, snowy or icy ground.

Furthermore, it is known, and has been normal for a great many years, to use, in tyres, rubber compositions having an elastomer matrix which is crosslinked with sulphur; this crosslinking is then known as vulcanization. The conventional vulcanization system combines sulphur and at least one vulcanization accelerator. The vulcanization systems have been improved over the years, in combination with the processes for the preparation of the rubber compositions. Thus, the compositions are often complex and comprise, in addition to the sulphur or an agent which donates sulphur, vulcanization accelerators, activators and optionally vulcanization retardants.

These highly complex vulcanization systems are only really effective for polymer matrices which are rich in unsaturations, which is not the case for polymers having chains which are predominantly olefinic. At present, it would be advantageous for manufacturers to find crosslinking systems which are as successful as vulcanization, while simplifying the compositions and their preparation, and which are better suited to the crosslinking of predominantly olefinic polymers.

On continuing their research studies, the Applicant Companies have now found that specific compositions for tyres can be prepared in a simplified manner, with respect to the conventionally vulcanized compositions based on diene elastomers, and that these compositions can exhibit improvements in the stiffness.

Consequently, a first subject-matter of the invention is a tyre comprising a rubber composition based on at least one olefinic elastomer comprising epoxide functional groups as predominant elastomer, at least one reinforcing filler and a crosslinking system comprising a polycarboxylic acid of general formula (I):

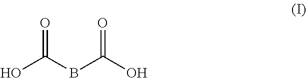

in which B represents a hydrocarbon group which comprises at least 50 carbon atoms, which is optionally substituted and which is optionally interrupted by one or more heteroatoms,
and an imidazole of general formula (II):

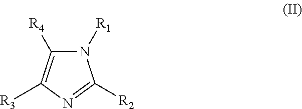

in which:
R₁ represents a hydrocarbon group or a hydrogen atom,
R₂ represents a hydrocarbon group,
R₃ and R₄ represent, independently of one another, a hydrogen atom or a hydrocarbon group,
or else R₃ and R₄ form, together with the carbon atoms of the imidazole ring to which they are attached, a ring.

Preferably, a subject-matter of the invention is a tyre as defined above, in which B represents a divalent hydrocarbon group comprising from 50 to 1800 carbon atoms. More preferably, B represents a divalent hydrocarbon group comprising from 50 to 1000 carbon atoms. More preferably still, B represents a divalent hydrocarbon group comprising from 80 to 500 carbon atoms. Very preferably, B represents a divalent hydrocarbon group comprising from 100 to 300 carbon atoms.

Preferably, a subject-matter of the invention is a tyre as defined above, in which B is a divalent group of aliphatic or aromatic type or a group comprising at least an aliphatic portion and an aromatic portion. Preferably, B is a divalent group of aliphatic type or a group comprising at least an aliphatic portion and an aromatic portion. More preferably, B is a divalent group of saturated or unsaturated aliphatic type. Very preferably, B is an alkylene group.

Preferably, a subject-matter of the invention is a tyre as defined above, in which B is interrupted by at least one heteroatom chosen from oxygen, nitrogen and sulphur, preferably oxygen.

Preferably again, a subject-matter of the invention is a tyre as defined above, in which B is substituted by at least one radical chosen from alkyl, cycloalkylalkyl, aryl, aralkyl, hydroxyl, alkoxy, amino and carbonyl radicals. More preferably, B is substituted by one or more carboxylic acid functional groups and/or by one or more hydrocarbon radicals chosen from alkyl, cycloalkyl, cycloalkylalkyl, aryl or aralkyl radicals, themselves substituted by one or more carboxylic acid functional groups. Alternatively and more preferably again, B does not comprise another carboxylic acid functional group.

Preferably, a subject-matter of the invention is a tyre as defined above, in which the content of polyacid is within a range extending from 2 to 100 phr and preferably from 2 to 50 phr. More preferably, the content of polyacid is within a range extending from 5 to 50 phr, preferably from 5 to 30 phr.

Preferably, a subject-matter of the invention is a tyre as defined above, in which:
R₁ represents a hydrogen atom or an alkyl group having from 1 to 20 carbon atoms, a cycloalkyl group having from 5 to 24 carbon atoms, an aryl group having from 6 to 30 carbon atoms or an aralkyl group having from 7 to 25 carbon atoms, which group can optionally be interrupted by one or more heteroatoms and/or substituted,
R₂ represents an alkyl group having from 1 to 20 carbon atoms, a cycloalkyl group having from 5 to 24 carbon atoms, an aryl group having from 6 to 30 carbon atoms or an aralkyl group having from 7 to 25 carbon atoms, which group can optionally be interrupted by one or more heteroatoms and/or substituted,
R₃ and R₄ independently represent identical or different groups chosen from hydrogen or alkyl groups having from 1 to 20 carbon atoms, cycloalkyl groups having from 5 to 24 carbon atoms, aryl groups having from 6 to 30 carbon atoms or aralkyl groups having from 7 to 25 carbon atoms, which groups can optionally be interrupted by heteroatoms and/or substituted, or else R₃ and R₄ form, together with the carbon atoms of the imidazole ring to which they are attached, a ring chosen from aromatic, heteroaromatic or aliphatic rings comprising from 5 to 12 carbon atoms, preferably 5 or 6 carbon atoms.

Preferably, a subject-matter of the invention is a tyre as defined above, in which R₁ represents a group chosen from alkyl groups having from 2 to 12 carbon atoms or aralkyl groups having from 7 to 13 carbon atoms, which groups can optionally be substituted.

Preferably again, a subject-matter of the invention is a tyre as defined above, in which R₁ represents an optionally substituted aralkyl group having from 7 to 13 carbon atoms and R₂ represents an alkyl group having from 1 to 12 carbon atoms. More preferably, R₁ represents an optionally substituted aralkyl group having from 7 to 9 carbon atoms and R₂ represents an alkyl group having from 1 to 4 carbon atoms.

Preferably, a subject-matter of the invention is a tyre as defined above, in which R₃ and R₄ independently represent identical or different groups chosen from hydrogen or alkyl groups having from 1 to 12 carbon atoms, cycloalkyl groups having from 5 to 8 carbon atoms, aryl groups having from 6 to 24 carbon atoms or aralkyl groups having from 7 to 13 carbon atoms, which groups can optionally be substituted.

Preferably again, a subject-matter of the invention is a tyre as defined above, in which R₃ and R₄ form, with the carbon atoms of the imidazole ring to which they are attached, a benzene, cyclohexene or cyclopentene ring.

Preferably, a subject-matter of the invention is a tyre as defined above, in which the imidazole content is within a range extending from 0.5 to 4 molar equivalents and preferably from 0.5 to 3 molar equivalents, with respect to the carboxylic acid functional groups present on the polycarboxylic acid of general formula (I). More preferably, the imidazole content is within a range extending from 0.5 to 2.5 molar equivalents, preferably from 0.5 to 2 molar equivalents and more preferably still from 0.5 to 1.5 molar equivalents, with respect to the carboxylic acid functional groups present on the polycarboxylic acid of general formula (I).

Preferably, a subject-matter of the invention is a tyre as defined above in which the olefinic elastomer comprising epoxide functional groups comprises between 50 and 95% (molar percentage) and more preferably between 65 et 85% (molar percentage) of olefin.

Preferably again, a subject-matter of the invention is a tyre as defined above in which the olefinic elastomer comprising epoxide functional groups is an epoxidized ethylenic elastomer.

Preferably, a subject-matter of the invention is a tyre as defined above in which the olefinic elastomer comprising epoxide functional groups represents from 30 to 100 phr, preferably from 50 to 100 phr, as a blend with from 0 to 70 phr, preferably from 0 to 50 phr, of one or more minor non-epoxidized elastomers. More preferably, the olefinic elastomer comprising epoxide functional groups represents all of the 100 phr of elastomer.

Preferably, a subject-matter of the invention is a tyre as defined above, in which the reinforcing filler comprises carbon black, silica or a mixture of carbon black and silica. Preferably, a subject-matter of the invention is a tyre as defined above, in which the content of reinforcing filler is between 20 and 200 phr.

The tyres in accordance with the invention are intended in particular for passenger vehicles as well as for two-wheel vehicles (motorcycles, bicycles), industrial vehicles chosen from vans, “heavy-duty” vehicles—i.e. underground, bus, heavy road transport vehicles (lorries, tractors, trailers), off-road vehicles, heavy agricultural vehicles or earthmoving equipment, aircraft, and other transportation or handling vehicles.

The invention and its advantages will be easily understood in the light of the description and implementational examples which follow.

### I. TESTS

The rubber compositions are characterized after curing by their mechanical and dynamic properties; they are also characterized by their crosslinking characteristics, as indicated below.

I.1. Mechanical Properties: Tensile Tests

These tensile tests make it possible to determine the elasticity stresses and the properties at break. Unless otherwise indicated, they are carried out in accordance with French Standard NF T 46-002 of September 1988. Processing the tensile recordings also makes it possible to plot the curve of modulus as a function of the elongation, the modulus used here being the nominal (or apparent) secant modulus measured in first elongation, calculated by reducing to the initial cross section of the test specimen. At second elongation (i.e. after an accommodation cycle at the extension rate provided for the measurement itself), the nominal secant modulus (or apparent stress, in MPa) is measured at 10% elongation (denoted by ASM10) or 50% elongation (denoted by ASM50). The tensile measurements for determining the accommodated secant moduli are carried out at a temperature of 23° C.+/−2° C. and under standard hygrometry conditions (50+/−5% relative humidity). These values are representative of the stiffness: the higher the value of the moduli, the greater the stiffness.

I.2. Dynamic Properties

The dynamic properties G* and tan(δ)max are measured on a viscosity analyser (Metravib VA4000) according to Standard ASTM D 5992-96. The response of a sample of crosslinked composition (cylindrical test specimen with a thickness of 4 mm and a cross section of 400 mm²), subjected to a simple alternating sinusoidal shear stress, at a frequency of 10 Hz, under standard temperature conditions (23° C.) according to Standard ASTM D 1349-99 or, as the case may be, at a different temperature, is recorded. A strain amplitude sweep is carried out from 0.1% to 100% (outward cycle) and then from 100% to 0.1% (return cycle). The results made use of are the complex dynamic shear modulus (G*) and the loss factor tan(δ). For the return cycle, the maximum value of tan(δ) observed, denoted tan(δ)max, is indicated. This value is representative of the hysteresis of the material and in the present case of the rolling resistance: the smaller the value of tan(δ)max, the lower the rolling resistance. The G* values, measured at 23° C., are representative of the stiffness, that is to say of the resistance to deformation: the higher the value of G*, the greater the stiffness of the material and thus the higher the wear resistance.

I.3. Crosslinking Characteristics: Rheometry

The measurements are carried out at 150° C. with an oscillating disc rheometer, according to Standard DIN 53529—Part 3 (June 1983). The change in the rheometric torque as a function of the time describes the change in the stiffening of the composition as a result of the crosslinking reaction. The measurements are processed according to Standard DIN 53529—Part 2 (March 1983):
ti is the induction period, that is to say the time necessary at the start of the crosslinking reaction,
talpha (for example t90) is the time necessary to achieve a conversion of alpha %, that is to say alpha % (for example 90%) of the difference between the minimum and maximum torques,
max torque achieved: value, measured in dN·m, of the maximum torque achieved for the composition during the test, corresponding to the crosslinking optimum under the conditions of the test.

I.4. Thermal Oxidation Characteristics: Test of Resistance to Thermal Oxidation

After curing, rubber blocks corresponding to the compositions for which the properties of resistance to thermal oxidation are to be evaluated are aged in an oven at a temperature of 85° C. under a relative humidity of 50% for 4 weeks.

The mechanical and dynamic properties described above can then be re-evaluated. The new values obtained can be expressed in base 100 with respect to the initial value before ageing for each composition, the resistance to thermal oxidation increasing as the value obtained approaches 100.

### II. COMPOSITION OF THE TYRES OF THE INVENTION

The tyre according to the invention comprises a rubber composition based on at least one olefinic elastomer comprising epoxide functional groups as predominant elastomer, at least one reinforcing filler and a crosslinking system comprising a polycarboxylic acid of general formula (I) and an imidazole of general formula (II).

The expression composition “based on” should be understood as meaning a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

The expression “molar equivalent”, which is well known to a person skilled in the art, should be understood as meaning the quotient of the number of moles of the compound concerned to the number of moles of the reference compound. Thus, 2 equivalents of a compound B with respect to a compound A represent 2 mol of the compound B when 1 mol of the compound A is used.

When reference is made to a “predominant” compound, this is understood to mean, within the meaning of the present invention, that this compound is predominant among the compounds of the same type in the composition, that is to say that it is the one which represents the greatest amount by weight among the compounds of the same type. Thus, for example, a predominant elastomer is the elastomer representing the greatest weight with respect to the total weight of the elastomers in the composition. In the same way, a “predominant” filler is that representing the greatest weight among the fillers of the composition. By way of example, in a system comprising just one elastomer, the latter is predominant within the meaning of the present invention and, in a system comprising two elastomers, the predominant elastomer represents more than half of the weight of the elastomers.

On the contrary, a “minor” compound is a compound which does not represent the greatest fraction by weight among the compounds of the same type.

In the present description, unless expressly indicated otherwise, all the percentages (%) shown are percentages (%) by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

II.1. Olefinic Elastomer Comprising Epoxide Functional Groups (or Epoxidized Olefinic Elastomer)

It should be remembered that elastomer or rubber (the two terms being in a known way synonymous and interchangeable) of the epoxidized olefinic type should be understood as meaning an epoxide-functionalized elastomer, that is to say that it bears epoxide functional groups, and the elastomeric chain of which is a carbon chain predominantly comprising olefin monomer units denoted O (molar content greater than 50%). More specifically, the molar content of O is between 50 and 95% and preferably between 65 and 85%. This olefinic elastomer is thus a copolymer also comprising from 5 to 50 mol % of non-olefinic units (that is to say different from O). These non-olefinic units are composed, partially or completely, of units bearing epoxide functional groups, denoted R, necessary for the requirements of the invention. In the case where not all the non-olefinic units are R units, other units, denoted A, are present in the carbon chain in such a way that the molar ratio of R+A is strictly less than 50%.

The monomers O can originate from any olefin known to a person skilled in the art, such as, for example, ethylene, propylene, butylene or isobutylene, these monomers optionally being substituted by linear or branched alkyl groups.

Preferably, O is an ethylene [—CH₂—CH₂—] unit and, in this preferred case, the epoxidized olefinic elastomer is an epoxidized ethylenic elastomer, which makes it possible to improve even more the compromise between the stiffness and hysteresis performances in the compositions for tyres.

An essential characteristic of the epoxidized olefinic elastomer of use for the requirements of the invention is that it is functionalized, bearing epoxide functional groups.

The epoxide functional group can be borne directly by the carbon backbone and is then mainly obtained by epoxidation of carbon-carbon double bonds initially present after copolymerization. This epoxidation of unsaturated polymers is well known to a person skilled in the art and can be carried out, for example, by processes based on chlorohydrin or bromohydrin, direct oxidation processes or processes based on hydrogen peroxides, on alkyl hydroperoxides or on peracids (such as peracetic acid or performic acid).

The epoxide functional group can also be pendant and is then either already present in a monomer involved in the copolymerization with the olefin (this monomer can, for example, be glycidyl methacrylate, allyl glycidyl ether or vinyl glycidyl ether) or obtained by the post-copolymerization modification of a pendant functional group.

The content (mol %) of R units of the epoxidized olefinic elastomers described above can vary to a great extent according to the specific embodiments of the invention, preferably within a range from 0.1% to 50%, preferably within a range from 2% to 50% and more preferably within a range from 2% to 20%. When the content of R units is less than 0.1%, there is a risk of the targeted technical effect being insufficient whereas, above 50%, the elastomer would no longer be predominantly olefinic.

When the non-olefinic units are not composed entirely of R units bearing an epoxide functional group, other non-olefinic units A are present in the chain, so that the total molar content represented by the monomers O, R and A is equal to 100%. The non-olefinic monomers of use in the preparation of the epoxidized olefinic elastomers can be chosen from non-olefinic monomers which do not result in unsaturations and monomers which, once polymerized, result in unsaturations in the elastomer chain, such as diene monomers.

The non-olefinic monomers which do not result in unsaturations are essentially vinyl and acrylic/methacrylic monomers. For example, such monomers can be chosen from styrene, vinyl acetate, vinyl alcohol, acrylonitrile, methyl acrylate or methyl methacrylate, these monomers optionally being substituted by alkyl or aryl groups or other functionalized groups.

For example again, the diene monomers of use in the preparation of the elastomers of olefinic type by copolymerization are all those known to a person skilled in the art to form unsaturated elastomers, such as those chosen from isoprene, butadiene, 1,3-pentadiene and 2,4-hexadiene, these monomers optionally being substituted.

The epoxidized olefinic elastomers described above are in a known way solid at ambient temperature (20° C.); solid is understood to mean any substance not having the ability to eventually assume, at the latest after 24 hours, solely under the effect of gravity and at ambient temperature (20° C.), the shape of the container in which it is present.

The epoxidized olefinic elastomers exhibit a Tg which in the very great majority of cases is negative (that is to say, less than 0° C.). The Tg of the elastomers described above is measured in a known way by DSC (Differential Scanning calorimetry), for example and unless specifically indicated otherwise in the present patent application according to Standard ASTM D3418 of 1999.

The epoxidized olefinic elastomers exhibit a number-average molar mass (Mₙ) of at least 20 000 g/mol and of at most 1 500 000 g/mol. The polydispersity index PDI, equal to M_{w}/Mₙ (M_{w} being the weight-average molar mass), is between 1.05 and 9.00.

Preferably, and to sum up, the olefinic elastomer comprising epoxide functional groups is thus a copolymer having at least 50% (in moles) of olefin monomer units and with a number of different monomer units of greater than or equal to 2, preferably from 2 to 5 and more preferably 2 or 3. This copolymer can be obtained by copolymerization or by post-polymerization modification of an elastomer. The epoxide functional groups present in the olefinic copolymer, obtained by copolymerization or by post-polymerization modification, will either be borne directly by the backbone of the chain or will be borne by a side group, depending on the method of preparation, for example by epoxidation or any other modification of the diene functional groups present in the elastomeric chain after copolymerization.

Epoxidized olefinic elastomers and their processes of preparation are well known to a person skilled in the art and are commercially available. Olefinic elastomers bearing epoxide groups have been described, for example, in the documents EP 0 247 580 and U.S. Pat. No. 5,576,080. Also, Arkema commercially provides epoxidized polyethylenes under the trade names Lotader AX8840 and Lotader AX8900.

The compositions of the tyres of the invention can comprise just one epoxidized olefinic elastomer or a mixture of several epoxidized olefinic elastomers (which will then be denoted in the singular as being “the epoxidized olefinic elastomer” in order to represent the sum of the epoxidized elastomers of the composition), it being possible for the epoxidized olefinic elastomer to be used in combination with any type of non-epoxidized elastomer, for example diene elastomer, indeed even with elastomers other than diene elastomers.

The epoxidized olefinic elastomer is predominant in the rubber composition of the tyre of the invention, that is to say that it is either the only elastomer or it is that which represents the greatest weight among the elastomers of the composition.

According to a preferred embodiment of the invention, the rubber composition comprises, for example, from 30 to 100 phr, in particular from 50 to 100 phr and preferably from 70 to 100 phr of a predominant epoxidized olefinic elastomer as a blend with from 0 to 70 phr, in particular from 0 to 50 phr and preferably from 0 to 30 phr of one or more other minor elastomers.

According to another preferred embodiment of the invention, the composition comprises, for the whole of the 100 phr of elastomer, one or more epoxidized olefinic elastomers.

II.2. Reinforcing Filler

Use may be made of any type of reinforcing filler known for its abilities to reinforce a rubber composition which can be used for the manufacture of tyres, for example an organic filler, such as carbon black, a reinforcing inorganic filler, such as silica, or also a blend of these two types of filler, in particular a blend of carbon black and silica.

All carbon blacks, in particular blacks of the HAF, ISAF or SAF type, conventionally used in tyres (“tyre-grade” blacks), are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example N660, N683 or N772). The carbon blacks might, for example, be already incorporated in an isoprene elastomer in the form of a masterbatch (see, for example, Application WO 97/36724 or WO 99/16600).

Mention may be made, as examples of organic fillers other than carbon blacks, of functionalized polyvinyl organic fillers, such as described in Applications WO-A-2006/069792, WO-A-2006/069793, WO-A-2008/003434 and WO-A-2008/003435.

“Reinforcing inorganic filler” should be understood, in the present patent application, by definition, as meaning any inorganic or mineral filler (whatever its colour and its origin, natural or synthetic), also known as “white filler”, “clear filler” or indeed even “non-black filler”, in contrast to carbon black, capable of reinforcing by itself alone, without means other than an optional intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state under which the reinforcing inorganic filler is provided is not important, whether it is in the form of a powder, of microbeads, of granules, of beads or any other appropriate densified form. Of course, reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

The reinforcing inorganic filler used, in particular if it is silica, preferably has a BET specific surface of between 45 and 400 m²/g, more preferably of between 60 and 300 m²/g.

Preferably, the content of total reinforcing filler (carbon black and/or reinforcing inorganic filler, such as silica) is between 20 and 200 phr, more preferably between 30 and 150 phr, the optimum being, in a known way, different depending on the specific applications targeted: the level of reinforcement expected with regard to a bicycle tyre, for example, is, of course, less than that required with regard to a tyre capable of running at high speed in a sustained manner, for example a motorcycle tyre, a tyre for a passenger vehicle or a tyre for a utility vehicle, such as a heavy-duty vehicle.

According to a preferred embodiment of the invention, use is made of a reinforcing filler comprising between 30 and 150 phr, more preferably between 50 and 120 phr, of organic filler, particularly of carbon black, and optionally silica; the silica, when it is present, is preferably used at a content of less than 20 phr, more preferably of less than 10 phr (for example between 0.1 and 10 phr).

Alternatively, according to another preferred embodiment of the invention, use is made of a reinforcing filler comprising between 30 and 150 phr, more preferably between 50 and 120 phr, of inorganic filler, particularly of silica, and optionally carbon black; the carbon black, when it is present, is preferably used at a content of less than 20 phr, more preferably of less than 10 phr (for example between 0.1 and 10 phr).

The coupling between the inorganic filler and the ethylenic elastomer can be provided, in part, by the interactions of chemical and/or physical nature existing between the two entities.

Nevertheless, in order to intensify the coupling between the reinforcing inorganic filler and the elastomer, use may be made, in a known way, of a coupling agent (or bonding agent), for example a bifunctional one, intended to provide a satisfactory connection, of chemical and/or physical nature, between the inorganic filler (surface of its particles) and the elastomer, in particular bifunctional organosilanes or polyorganosiloxanes.

In the rubber compositions in accordance with the invention, the content of coupling agent is preferably from 0 to 12 phr, more preferably between 0 and 8 phr.

A person skilled in the art will understand that, as filler equivalent to the reinforcing inorganic filler described in the present section, use might be made of a reinforcing filler of another nature, in particular organic nature, provided that this reinforcing filler is covered with an inorganic layer, such as silica, or else comprises functional sites, in particular hydroxyl sites, at its surface requiring the use of a coupling agent in order to form the bond between the filler and the elastomer.

II.3. Crosslinking System

The epoxidized olefinic elastomer and the reinforcing filler described above are combined with a crosslinking system capable of crosslinking it or curing the composition of the tyre according to the invention. This crosslinking system comprises a (that is to say, at least one) polycarboxylic acid of general formula (I) and an (that is to say, at least one) imidazole of general formula (II).

II.3.a. Polyacid

The polyacid of use for the requirements of the invention is a polycarboxylic acid of general formula (I):

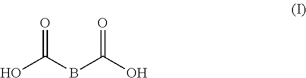

in which B represents a hydrocarbon group which comprises at least 50 carbon atoms, which is optionally substituted and which is optionally interrupted by one or more heteroatoms.

Preferably, in the polyacid of general formula (I), B represents a divalent hydrocarbon group comprising from 50 to 1800 carbon atoms, preferably from 50 to 1000 carbon atoms, more preferably from 80 to 500 carbon atoms and very preferably from 100 to 300 carbon atoms. Above 1800 carbon atoms, the polyacid is a less effective crosslinking agent. Below 50 carbon atoms, the hysteresis of the compositions is not as much improved for the compositions comprising the polyacids.

Preferably, in the polyacid of general formula (I), B can be a divalent group of aliphatic or aromatic type or a group comprising at least an aliphatic portion and an aromatic portion. Preferably, B can be a divalent group of aliphatic type or a group comprising at least an aliphatic portion and an aromatic portion. Alternatively and preferably again, B can be a divalent group of saturated or unsaturated aliphatic type, for example an alkylene group.

The B group of the polyacid of general formula (I) can be interrupted by at least one heteroatom chosen from oxygen, nitrogen and sulphur, preferably oxygen.

Also, the B group of the polyacid of general formula (I) can be substituted by at least one radical chosen from alkyl, cycloalkylalkyl, aryl, aralkyl, hydroxyl, alkoxy, amino and carbonyl radicals.

The polyacid of general formula (I) can comprise more than two carboxylic acid functional groups; in this case, the B group is substituted by one or more carboxylic acid functional groups and/or by one or more hydrocarbon radicals chosen from alkyl, cycloalkyl, cycloalkylalkyl, aryl or aralkyl radicals, themselves substituted by one or more carboxylic acid functional groups.

According to a preferred form, the B radical does not comprise another carboxylic acid functional group; the polyacid is thus a diacid.

The content of polyacid is preferably within a range extending from 2 to 100 phr, preferably from 2 to 50 phr, more preferably from 5 to 50 phr and more preferably still from 5 to 30 phr. Below 2 phr of polyacid, the effect of the crosslinking is not substantial, whereas, above 100 phr of polyacid, the polyacid, the crosslinking agent, becomes predominant by weight with respect to the elastomeric matrix.

The polyacids of use for the requirements of the invention are either commercially available or are easily prepared by a person skilled in the art according to well-known techniques as described, for example, in the document EP 1072613 and also in the references cited in this document.

For example, mention may be made, as polyacids which are commercially available and which are of use for the requirements of the invention, of:

Polybutadiene, dicarboxy terminated (Aldrich, CAS 68891-79-2)

Poly(acrylonitrile-co-butadiene), dicarboxy terminated (Aldrich, CAS 68891-46-3)

Poly(ethylene oxide), 4-arm, carboxylic acid terminated (Aldrich)

Poly(ethylene glycol)bis(carboxymethyl) ether (Aldrich, CAS 39927-08-7)

Polybutadiene, dicarboxy terminated (Sartomer, Krasol LBM32).

II.3.b. Imidazole

The imidazole of use for the crosslinking system of the tyre of the invention is an imidazole of general formula (II):

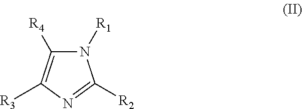

in which:
R₁ represents a hydrocarbon group or a hydrogen atom,
R₂ represents a hydrocarbon group,
R₃ and R₄ represent, independently of one another, a hydrogen atom or a hydrocarbon group,
or else R₃ and R₄ form, together with the carbon atoms of the imidazole ring to which they are attached, a ring.

Preferably, the imidazole of general formula (II) has groups such that:
R₁ represents a hydrogen atom or an alkyl group having from 1 to 20 carbon atoms, a cycloalkyl group having from 5 to 24 carbon atoms, an aryl group having from 6 to 30 carbon atoms or an aralkyl group having from 7 to 25 carbon atoms, which group can optionally be interrupted by one or more heteroatoms and/or substituted,
R₂ represents an alkyl group having from 1 to 20 carbon atoms, a cycloalkyl group having from 5 to 24 carbon atoms, an aryl group having from 6 to 30 carbon atoms or an aralkyl group having from 7 to 25 carbon atoms, which group can optionally be interrupted by one or more heteroatoms and/or substituted,
R₃ and R₄ independently represent identical or different groups chosen from hydrogen or alkyl groups having from 1 to 20 carbon atoms, cycloalkyl groups having from 5 to 24 carbon atoms, aryl groups having from 6 to 30 carbon atoms or aralkyl groups having from 7 to 25 carbon atoms, which groups can optionally be interrupted by heteroatoms and/or substituted, or else R₃ and R₄ form, together with the carbon atoms of the imidazole ring to which they are attached, a ring chosen from aromatic, heteroaromatic or aliphatic rings comprising from 5 to 12 carbon atoms, preferably 5 or 6 carbon atoms.

Preferably, R₁ represents a group chosen from alkyl groups having from 2 to 12 carbon atoms or aralkyl groups having from 7 to 13 carbon atoms, which groups can optionally be substituted. More preferably, R₁ represents an optionally substituted aralkyl group having from 7 to 13 carbon atoms and R₂ represents an alkyl group having from 1 to 12 carbon atoms. More preferably still, R₁ represents an optionally substituted aralkyl group having from 7 to 9 carbon atoms and R₂ represents an alkyl group having from 1 to 4 carbon atoms.

Preferably, R₃ and R₄ independently represent identical or different groups chosen from hydrogen or alkyl groups having from 1 to 12 carbon atoms, cycloalkyl groups having from 5 to 8 carbon atoms, aryl groups having from 6 to 24 carbon atoms or aralkyl groups having from 7 to 13 carbon atoms, which groups can optionally be substituted. Alternatively and preferably again, R₃ and R₄ form, with the carbon atoms of the imidazole ring to which they are attached, a benzene, cyclohexene or cyclopentene ring.

For good operation of the invention, the imidazole content is preferably within a range extending from 0.5 to 4 molar equivalents and preferably from 0.5 to 3 molar equivalents, with respect to the carboxylic acid functional groups present on the polycarboxylic acid of general formula (I). Below 0.5 molar equivalent, no effect of the imidazole coagent is observed in comparison with the situation where the polyacid is used alone, whereas, above a value of 4 molar equivalents, no additional benefit is observed in comparison with lower contents. Thus, the imidazole content is more preferably within a range extending from 0.5 to 2.5 molar equivalents, preferably from 0.5 to 2 molar equivalents and more preferably still from 0.5 to 1.5 molar equivalents, with respect to the carboxylic acid functional groups present on the polycarboxylic acid of general formula (I).

The imidazoles of use for the requirements of the invention are either commercially available or are easily prepared by a person skilled in the art according to well-known techniques, such as described, for example, in the documents JP2012211122 and JP2007269658 or also in Science of Synthesis, 2002, 12, 325-528.

For example, mention may be made, as imidazoles which are commercially available and which are of use for the requirements of the invention, of 1,2-dimethylimidazole, 1-decyl-2-methylimidazole or 1-benzyl-2-methylimidazole.

II.3.c. Polyacid and Imidazole

Obviously and in accordance with the definition of the expression “based on” for the present invention, a composition based on the polyacid of general formula (I) and on the imidazole of general formula (II) which are presented above might be a composition in which the said polyacid and the said imidazole have reacted together beforehand to form a salt between one or more acid functional groups of the polyacid and respectively one or more imidazole nuclei.

II.4. Various Additives

The rubber compositions of the tyres in accordance with the invention can also comprise all or a portion of the usual additives generally used in elastomer compositions intended for the manufacture of treads, such as, for example, pigments, protection agents, such as antiozone waxes, chemical antiozonants or antioxidants, antifatigue agents, crosslinking agents other than those mentioned above, reinforcing resins or plasticizing agents. Preferably, this plasticizing agent is a solid hydrocarbon resin (or plasticizing resin), an extending oil (or plasticizing oil) or a mixture of the two.

These compositions can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

Preferably, the compositions of the tyres of the invention are devoid of a crosslinking system other than that described above and which comprises at least one polyacid and at least one imidazole. In other words, the crosslinking system based on at least one polyacid and at least one imidazole is preferably the only crosslinking system in the composition of the tyre of the invention. Preferably, the compositions of the tyres of the invention are devoid of a vulcanization system or comprise less than 1 phr, preferably less than 0.5 phr and more preferably less than 0.2 phr thereof. Thus, the composition of the tyre according to the invention is preferably devoid of molecular sulphur or comprises less than 1 phr, preferably less than 0.5 phr and more preferably less than 0.2 phr thereof. Likewise, the composition is preferably devoid of any vulcanization accelerator as known to a person skilled in the art or comprises less than 1 phr, preferably less than 0.5 phr and more preferably less than 0.2 phr thereof.

II.5. Preparation of the Rubber Compositions

The compositions used in the tyres of the invention can be manufactured in appropriate mixers, using two successive phases of preparation well known to a person skilled in the art: a first phase of thermomechanical working or kneading (“non-productive” phase) at high temperature, up to a maximum temperature of between 100° C. and 190° C., preferably between 120° C. and 180° C., followed by a second phase of mechanical working (“productive” phase) down to a lower temperature, typically of less than 100° C., for example between 40° C. and 100° C., during which finishing phase the crosslinking system can be incorporated. A person skilled in the art will know how to adjust the temperature in the mixers as a function of the nature of the epoxidized ethylenic elastomers.

As the case may be, for the implementation of the invention, the crosslinking system is either introduced into the internal mixer with all the other constituents of the composition or is introduced during the productive phase described above.

The final composition thus obtained can subsequently be calendered, for example in the form of a sheet or of a plaque, in particular for laboratory characterization, or also extruded, for example in order to form a rubber profiled element used in the manufacture of the tyre of the invention.

II.6. Tyre of the Invention

The rubber composition of the tyre according to the invention can be used in different parts of the said tyre, in particular in the crown, the area of the bead, the area of the sidewall and the tread (in particular in the underlayer of the tread).

According to a preferred embodiment of the invention, the rubber composition described above can be used in the tyre as an elastomer layer in at least one part of the tyre.

Elastomer “layer” is understood to mean any three-dimensional component, made of rubber (or “elastomer”, the two being regarded as synonyms) composition, having any shape and thickness, in particular sheet, strip or other component having any cross section, for example rectangular or triangular.

First of all, the elastomer layer can be used as tread underlayer positioned in the crown of the tyre between, on the one hand, the tread, i.e. the portion intended to come into contact with the road during running, and, on the other hand, the belt reinforcing the said crown. The thickness of this elastomer layer is preferably within a range extending from 0.5 to 10 mm, in particular within a range from 1 to 5 mm.

According to another preferred embodiment of the invention, the rubber composition according to the invention can be used to form an elastomer layer positioned in the region of the area of the bead of the tyre, radially between the carcass ply, the bead wire and the turn-up of the carcass ply.

Equally, the composition according to the invention can be used in the plies of the crown (tyre belt) or in the area between the ends of the plies of the crown and the carcass ply.

Another preferred embodiment of the invention can be the use of the composition according to the invention to form an elastomer layer positioned in the area of the sidewall of the tyre.

Alternatively, the composition of the invention can advantageously be used in the tread of the tyre.

### III. EXAMPLES OF THE IMPLEMENTATION OF THE INVENTION

### III.1. Preparation of the Compositions

The following tests are carried out in the following way: the epoxidized ethylenic elastomer, the reinforcing filler, the polyacid, the imidazole and the other additives are successively introduced into an internal mixer (final degree of filling: approximately 70% by volume), the initial vessel temperature of which is approximately 80° C. Thermomechanical working (non-productive phase) is then carried out in one stage, which lasts in total approximately from 2 to 4 min, until a maximum “dropping” temperature ranging from 135° C. to 165° C., depending on the compositions, is reached. The introduction of the conventional sulphur-comprising vulcanization system present in some compositions not in accordance with the invention is carried out during a second phase of mechanical working at 80° C.

The mixture thus obtained is recovered and cooled, and the compositions thus obtained are subsequently calendered, either in the form of plaques (thickness from 2 to 3 mm) or of thin sheets of rubber, for the measurement of their physical or mechanical properties, or extruded in the form of a profiled element.

### III.2. Example 1

This test also illustrates rubber compositions which can be used in particular as tread of the tyre of the invention. These compositions exhibit an ease of preparation and a simplicity superior to a conventional rubber composition (vulcanized with sulphur), while also improving the hysteresis of the compositions in comparison with the compositions vulcanized with sulphur.

For this, rubber compositions were prepared as indicated above, some of which in accordance with the invention (C3) and some of which not in accordance (controls C1 and C2), as shown in Table 1.

TABLE 3

| | C1 | C2 | C3 |
|---|---|---|---|
| ENR25 (1) | 100 | 100 | |
| EPOXPE (2) | | | 100 |
| Silica (3) | 45 | 45 | 60 |
| Silane (4) | 4.5 | 4.5 | — |
| 6PPD (5) | 3 | 3 | — |
| Polyacid (6) | | 14.34 | 24.8 |
| Imidazole (7) | | 1.7 | 2.7 |
| Sulphur | 1.3 | | — |
| Accelerator (8) | 1.56 | | — |
| ZnO (9) | 2.7 | | — |
| Stearic acid (10) | 2.5 | | — |

(1) Epoxidized Natural Rubber, ENR25 from Guthrie Polymer;
(2) EPOXPE: epoxidized polyethylene, Lotader AX8900 from Arkema, comprising 8% of glycidyl methacrylate, 24% of methyl acrylate and 68% of ethylene;
(3) Silica 160 MP, Zeosil 1165MP from Rhodia;
(4) Dynasylan Octeo from Degussa;
(5) N-(1,3-Dimethylbutyl)-N-phenyl-para-phenylenediamine (Santoflex 6-PPD from Flexsys);
(6) Polybutadiene, dicarboxy terminated, CT3000 from Cray Valley, with a molar mass of 3000 g/mol;
(7) 1-Benzyl-2-methylimidazole, CAS = 13750-62-4, from Sigma-Aldrich;
(8) N-Cyclohexyl-2-benzothiazolesulphenamide (Santocure CBS from Flexsys);
(9) Zinc oxide (industrial grade, Umicore);
(10) Stearin (Pristerene 4931 from Uniqema).

Compositions C1 and C2 are compositions based on an elastomer bearing epoxide functional groups but which is predominantly diene, which are crosslinked with sulphur (conventional for the curing of tyres) or with the polyacid/imidazole crosslinking system put forward in the invention, whereas composition C3 is based on an epoxidized olefinic matrix crosslinked by a polyacid and an imidazole according to the invention.

The properties of compositions C1 to C3 were measured as indicated above and the results are shown in Table 2.

A greater simplicity of the mixture is noted in the composition of the invention, with fewer ingredients than in the vulcanized control compositions. Furthermore, it may be noted that the replacement of the conventional vulcanization system by a polyacid and imidazole crosslinking system results in an improvement in the hysteresis of the mixture, accompanied by a slight stiffening. This decrease in hysteresis, accompanied by an increase in stiffness, is intensified in the case of the replacement of the epoxidized diene matrix by an epoxidized polyolefin matrix crosslinked according to the invention.

TABLE 4

| | C1 | C2 | C3 |
|---|---|---|---|
| ASM50 (MPa) | 2.24 | 2.30 | 6.07 |
| G* (MPa) at 23° C., 10 Hz, 10% | 2.0 | 2.2 | 2.9 |
| tan(δ)max 23° C. return | 0.224 | 0.180 | 0.10 |

1.-29. (canceled)

30. A tire comprising a rubber composition which comprises:
at least one olefinic elastomer comprising epoxide functional groups as predominant elastomer;
at least one reinforcing filler; and
a crosslinking system comprising a polycarboxylic acid of general formula (I): 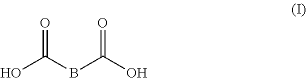
in which B represents a hydrocarbon group which comprises at least 50 carbon atoms, which is optionally substituted and which is optionally interrupted by one or more heteroatoms, and
an imidazole of general formula (II): 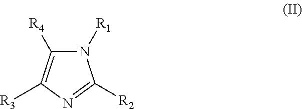
in which R₁ represents a hydrocarbon group or a hydrogen atom, R₂ represents a hydrocarbon group, R₃ and R₄ represent, independently of one another, a hydrogen atom or a hydrocarbon group, or else R₃ and R₄ form, together with the carbon atoms of the imidazole ring to which they are attached, a ring.

31. The tire according to claim 30, wherein B represents a divalent hydrocarbon group comprising from 50 to 1800 carbon atoms.

32. The tire according to claim 31, wherein B represents a divalent hydrocarbon group comprising from 50 to 100 carbon atoms.

33. The tire according to claim 30, wherein B represents a divalent hydrocarbon group comprising from 80 to 500 carbon atoms.

34. The tire according to claim 33, wherein B represents a divalent hydrocarbon group comprising from 100 to 300 carbon atoms.

35. The tire according to claim 30, wherein B is a divalent group of aliphatic or aromatic type or a group comprising at least an aliphatic portion and an aromatic portion.

36. The tire according to claim 30, wherein B is a divalent group of aliphatic type or a group comprising at least an aliphatic portion and an aromatic portion.

37. The tire according to claim 30, wherein B is a divalent group of saturated or unsaturated aliphatic type.

38. The tire according to claim 30, wherein B is an alkylene group.

39. The tire according to claim 30, wherein B is interrupted by at least one heteroatom selected from the group consisting of oxygen, nitrogen and sulphur.

40. The tire according to claim 39, wherein B is interrupted by at least oxygen.

41. The tire according to claim 30, wherein B is substituted by at least one radical selected from the group consisting of alkyl, cycloalkylalkyl, aryl, aralkyl, hydroxyl, alkoxy, amino and carbonyl radicals.

42. The tire according to claim 30, wherein B is substituted (a) by one or more carboxylic acid functional groups, (b) by one or more hydrocarbon radicals selected from the group consisting of alkyl, cycloalkyl, cycloalkylalkyl, aryl, and aralkyl radicals, themselves substituted by one or more carboxylic acid functional groups, or (c) by one or more carboxylic acid functional groups and by one or more hydrocarbon radicals selected from the group consisting of alkyl, cycloalkyl, cycloalkylalkyl, aryl, and aralkyl radicals, themselves substituted by one or more carboxylic acid functional groups.

43. The tire according to claim 30, wherein B does not comprise another carboxylic acid functional group.

44. The tire according to claim 30, wherein the content of polyacid is within a range extending from 2 to 100 phr.

45. The tire according to claim 44, wherein the content of polyacid is within a range extending from 2 to 50 phr.

46. The tire according to claim 45, wherein the content of polyacid is within a range extending from 5 to 50 phr.

47. The tire according to claim 46, wherein the content of polyacid is within a range extending from 5 to 30 phr.

48. The tire according to claim 30, wherein R₁ represents a hydrogen atom, an alkyl group having from 1 to 20 carbon atoms, a cycloalkyl group having from 5 to 24 carbon atoms, an aryl group having from 6 to 30 carbon atoms, or an aralkyl group having from 7 to 25 carbon atoms, which group can optionally be substituted, interrupted by one or more heteroatoms, or both,
wherein R₂ represents an alkyl group having from 1 to 20 carbon atoms, a cycloalkyl group having from 5 to 24 carbon atoms, an aryl group having from 6 to 30 carbon atoms, or an aralkyl group having from 7 to 25 carbon atoms, which group can optionally be substituted, interrupted by one or more heteroatoms, or both, and
wherein R₃ and R₄ independently represent identical or different groups selected from the group consisting of hydrogen, alkyl groups having from 1 to 20 carbon atoms, cycloalkyl groups having from 5 to 24 carbon atoms, aryl groups having from 6 to 30 carbon atoms, and aralkyl groups having from 7 to 25 carbon atoms, which groups can optionally be substituted, interrupted by heteroatoms, or both, or else R₃ and R₄ form, together with the carbon atoms of the imidazole ring to which they are attached, a ring selected from the group consisting of aromatic, heteroaromatic and aliphatic rings comprising from 5 to 12 carbon atoms.

49. The tire according to claim 48, wherein R₃ and R₄ form, together with the carbon atoms of the imidazole ring to which they are attached, a ring selected from the group consisting of aromatic, heteroaromatic and aliphatic rings comprising 5 or 6 carbon atoms.

50. The tire according to claim 30, wherein R₁ represents a group selected from the group consisting of alkyl groups having from 2 to 12 carbon atoms and aralkyl groups having from 7 to 13 carbon atoms, which groups can optionally be substituted.

51. The tire according to claim 30, wherein R₁ represents an optionally substituted aralkyl group having from 7 to 13 carbon atoms and R₂ represents an alkyl group having from 1 to 12 carbon atoms.

52. The tire according to claim 30, wherein R₁ represents an optionally substituted aralkyl group having from 7 to 9 carbon atoms and R₂ represents an alkyl group having from 1 to 4 carbon atoms.

53. The tire according to claim 30, wherein R₃ and R₄ independently represent identical or different groups selected from the group consisting of hydrogen, alkyl groups having from 1 to 12 carbon atoms, cycloalkyl groups having from 5 to 8 carbon atoms, aryl groups having from 6 to 24 carbon atoms, and aralkyl groups having from 7 to 13 carbon atoms, which groups can optionally be substituted.

54. The tire according to claim 30, wherein R₃ and R₄ form, with the carbon atoms of the imidazole ring to which they are attached, a benzene, cyclohexene or cyclopentene ring.

55. The tire according to claim 30, wherein the imidazole content is within a range extending from 0.5 to 4 molar equivalents with respect to the carboxylic acid functional groups present on the polycarboxylic acid of general formula (I).

56. The tire according to claim 55, wherein the imidazole content is within a range extending from 0.5 to 3 molar equivalents with respect to the carboxylic acid functional groups present on the polycarboxylic acid of general formula (I).

57. The tire according to claim 56, wherein the imidazole content is within a range extending from 0.5 to 2.5 molar equivalents with respect to the carboxylic acid functional groups present on the polycarboxylic acid of general formula (I).

58. The tire according to claim 57, wherein the imidazole content is within a range extending from 0.5 to 2 molar equivalents with respect to the carboxylic acid functional groups present on the polycarboxylic acid of general formula (I).

59. The tire according to claim 58, wherein the imidazole content is within a range extending from 0.5 to 1.5 molar equivalents with respect to the carboxylic acid functional groups present on the polycarboxylic acid of general formula (I).

60. The tire according to claim 30, wherein the olefinic elastomer comprising epoxide functional groups comprises between 50 and 95% of olefin (molar percentages).

61. The tire according to claim 60, wherein the olefinic elastomer comprising epoxide functional groups comprises between 65 and 85% of olefin (molar percentages).

62. The tire according to claim 30, wherein the olefinic elastomer comprising epoxide functional groups is an epoxidized ethylenic elastomer.

63. The tire according to claim 30, wherein the olefinic elastomer comprising epoxide functional groups represents from 30 to 100 phr as a blend with from 0 to 70 phr of one or more minor non-epoxidized elastomers.

64. The tire according to claim 63, wherein the olefinic elastomer comprising epoxide functional groups represents from 50 to 100 phr as a blend with from 0 to 50 phr of one or more minor non-epoxidized elastomers.

65. The tire according to claim 30, wherein the olefinic elastomer comprising epoxide functional groups represents all of the 100 phr of elastomer.

66. The tire according to claim 30, wherein the reinforcing filler comprises carbon black, silica, or a mixture of carbon black and silica.

67. The tire according to claim 30, wherein the content of reinforcing filler is between 20 and 200 phr.
